(19) United States
(12) Patent Application Publication
(10) Pub. No.: US 2023/0371694 A1
(43) Pub. Date: Nov. 23, 2023

(54) PADDING SYSTEM FOR AMUSEMENT PARK ATTRACTION SYSTEM

(71) Applicant: Universal City Studios LLC, Universal City, CA (US)

(72) Inventor: Daniel Anthony Niecestro, Winter Garden, FL (US)

(21) Appl. No.: 17/851,490

(22) Filed: Jun. 28, 2022

Related U.S. Application Data
(60) Provisional application No. 63/342,914, filed on May 17, 2022.

(51) Int. Cl. A47C 7/02; B60N 2/882; B60N 2/64

(52) U.S. Cl. CPC A47C 7/021; B60N 2/882; B60N 2/643; B60R 2021/0097

(57) ABSTRACT

A seat for an amusement park attraction system includes a padding system and a base configured to support a guest. The padding system includes a first side that is guest-facing, a second side that is base-facing and opposite the first side, a first pad portion coupled to the base, and a second pad portion coupled to the base. The seat also includes a seam formed by an interface between a first end of the first pad portion and a second end of the second pad portion such that the seam defines an overlap of the first pad portion and the second pad portion along an axis extending from the first side to the second side of the padding system.

### CROSS-REFERENCE TO RELATED APPLICATION

This application claims priority to and the benefit of U.S. Provisional Application No. 63/342,914, entitled “PADDING SYSTEM FOR AMUSEMENT PARK ATTRACTION SYSTEM” and filed May 17, 2022, which is incorporated by reference herein in its entirety for all purposes.

### BACKGROUND

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

An amusement park or other entertainment venue may include a variety of features to entertain guests or patrons. For example, the amusement park may have various attractions, which may include a ride, a performance show, decorations or props, and so forth. An attraction may include a guest support, such as a seat, that may facilitate placement of a guest in a desirable position and/or orientation to experience the attraction. For instance, the guest support may enable the guest to sit during operation of the attraction, which may include movement of a ride vehicle configured to carry the guest to different locations of the attraction. It may be desirable to improve comfort of the guest positioned against the guest support and correspondingly improve an experience provided by the guest via the attraction.

### BRIEF DESCRIPTION

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a seat for an amusement park attraction system includes a padding system and a base configured to support a guest. The padding system includes a first side that is guest-facing, a second side that is base-facing and opposite the first side, a first pad portion coupled to the base, and a second pad portion coupled to the base. The seat also includes a seam formed by an interface between a first end of the first pad portion and a second end of the second pad portion such that the seam defines an overlap of the first pad portion and the second pad portion along an axis extending from the first side to the second side of the padding system.

In an embodiment, an amusement park attraction system includes a guest support that has a base having a base surface and a padding system. The padding system includes a first pad with a guest-facing surface and configured to engage with the base surface, and the padding system includes a second pad configured to engage with the base surface to form an overlap between a first end of the first pad and a second end of the second pad along an axis extending from the base surface to the guest-facing surface in an installed configuration of the padding system.

In an embodiment, a seat includes a base having a surface, a first pad coupled to the surface of the base at a first base-facing side of the first pad, a second pad coupled to the surface of the base at a second base-facing side of the second pad, and a seam formed by an interface between a first end of the first pad and a second end of the second pad. The first end and the second end overlap with one another at the seam along a guest engagement axis extending through the first pad, the second pad, and the base.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of an embodiment of an attraction system, in accordance with an aspect of the present disclosure;

FIG. 2 is a perspective view of an embodiment of an attraction system with a ride vehicle, in accordance with an aspect of the present disclosure;

FIG. 3 is a front view of an embodiment of a ride vehicle with seats and a padding system, in accordance with an aspect of the present disclosure;

FIG. 4 is a side view of an embodiment of a ride vehicle with a seat and a padding system, in accordance with an aspect of the present disclosure;

FIG. 5 is a side view of an embodiment of a ride vehicle with a seat and a padding system, in accordance with an aspect of the present disclosure; and

FIG. 6 is a front view of an embodiment of a ride vehicle with a seat and a padding system, in accordance with an aspect of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The present disclosure is directed to an amusement or theme park. The amusement park may include a variety of features, such as rides (e.g., a roller coaster), theatrical shows, performers, and/or show set props. An attraction system of the amusement park may include a support (e.g., a guest support) that may be configured to facilitate positioning of a guest in the attraction system. For example, the attraction system may include a seat on which a guest may sit. During operation, the attraction system may entertain the guest engaged with the support, such as by moving the guest (e.g., via a ride vehicle having the support) and/or providing show effects to the guest. The guest may remain positioned against the support during operation of the attraction system.

It may be desirable to provide the guest with a comfortable experience during operation of the attraction system. For this reason, a padding or cushion system may be incorporated with the support to provide comfortable positioning of the guest against the support. As an example, the support may include a base, which may be made of a firm, hard, or stiff material to provide a desirable structural rigidity or stability. For instance, the base may be configured to withstand a force (e.g., a weight of a guest or additional forces imparted by centrifugal forces and the like) and remain secured within the attraction system. The padding system may include pads that may be coupled to the base, and the pads may be made of a softer material as compared to the base. Thus, it may be more comfortable for the guest to be positioned against (e.g., lean against, seated on) the pads than to be positioned directly against the base.

The pads may be separate portions or parts that are individually, independently, or separately attachable to or removable from the base. For example, a first pad portion and a second pad portion may be coupled to the base, and one of the first pad portion or the second pad portion may be detached from the base while the other of the first pad portion or the second pad portion remains coupled to the base. Thus, a part of the padding system may be removed (e.g., for service) without having to adjust a remainder of the padding system, thereby increasing a flexibility associated with adjustment of the padding system. For instance, a portion, rather than an entirety, of the padding system may be adjusted based on need, thereby reducing a cost, an amount of material, and/or an amount of time associated with adjusting the padding system. Moreover, the first pad portion and the second pad portion may be positioned on the base to form a seam extending along the base between the pad portions. The first pad portion and the second pad portion may overlap (e.g., in an offset configuration) along the seam to block exposure of the base at the seam. As an example, the overlap between the first pad portion and the second pad portion may block contact between the base and a guest positioned against the padding system at the seam, such as while the guest imparts a force onto the padding system at the seam. As such, the positioning of the pad portions may further improve a comfort of the guest. Although the present disclosure primarily discusses implementation of the padding system in an amusement park setting, it should be noted that the padding system may be implemented in any suitable context, such as for a motor vehicle, a movie theater, a restaurant, a residential household, and so forth.

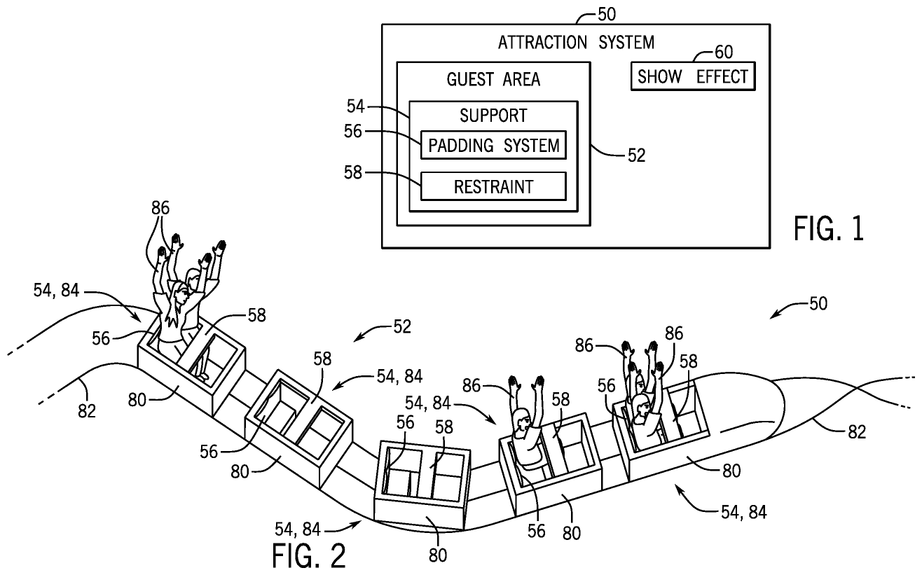

With the preceding in mind, FIG. 1 is a schematic diagram of an embodiment of an attraction system 50, which may be a roller coaster, a dark ride, a drop tower, a performance show, or any other suitable attraction system 50. The attraction system 50 may have a guest area 52 where guests may be positioned during operation of the attraction system 50. As an example, the guest area 52 may include a ride vehicle, an auditorium, a queue, and so forth. The guest area 52 may include a support or guest support 54 that may facilitate placement and positioning of the guests in the guest area 52. For instance, the support 54 may include a seat upon which a guest may sit, a wall against which a guest may rest, a mat on which a guest may stand, and the like. The support 54 may also include a padding system 56 with which the guests may contact during engagement with the support 54. The padding system 56 may improve comfort for the guests positioned in the guest area 52. For example, the padding system 56 may include a pad, a cushion, or similar material that may have a texture or other quality that may be more comfortable for the guests to contact. As such, the support 54 may improve the experience of the guests positioned in the guest area 52. Further, the padding system 56 incorporates offsetting component pads that facilitate maintenance, as will be discussed in further detail below.

In an embodiment, the support 54 may include a restraint 58 configured to secure a guest against the support 54, such as against the padding system 56. For example, the restraint 58 may include a lap bar, a seat belt, a harness, a strap, and the like. Thus, the padding system 56 and the restraint 58 may cooperatively secure the guests to the support 54. For instance, the guest area 52 may be configured to move along a path or track of the attraction system 50, and the guests may be contained within the guest area 52 via the restraint 58.

The attraction system 50 may also include show effects 60 that further enhance the experience of the guests. The show effects 60 may include lighting, sounds, animated figures, fog effects, and the like that provide additional features to entertain the guests. Indeed, the show effects 60 may be observable (e.g., viewable, audible) to the guests from the guest area 52, such as guests positioned against the support 54 and/or navigating around the guest area 52.

FIG. 2 is a side perspective view of an embodiment of the attraction system 50. In the illustrated embodiment, the guest area 52 of the attraction system 50 includes multiple ride vehicles 80 coupled together (e.g., via a link) and configured to travel along a path or track 82. The path 58 may guide the movement (e.g., direction, speed, and/or orientation) of the ride vehicles 80 through the attraction system 50. In an additional or an alternative embodiment, the ride path 82 may be an open surface along which the ride vehicles 80 may generally travel (e.g., guided based on a user input).

Each ride vehicle 80 may include the support 54, illustrated as one or more ride seats 84 that each may hold one or more passengers 86. For example, the illustrated attraction system 50 shows five ride vehicles 80 that each accommodate two passengers 86, but the guest area 52 may include any suitable number of ride vehicles 80, such as one, two, four, or more, and each ride vehicle 80 may accommodate any number of passengers 86, such as one passenger 86, three passengers 86, four passengers 86, or five or more passengers 86. Indeed, there may be any suitable number of ride vehicles 80 and/or passengers 86 in each of the ride vehicles 80.

Each ride vehicle 80 may include the restraint 58. The illustrated restraint 58 is configured to be positioned above the lap of each passenger 86. However, an additional or alternative restraint 58 may have any configuration, such as an arrangement in which the restraint 58 is positioned over a shoulder of each passenger 86, across a torso of each passenger 86, and so forth. Furthermore, the illustrated attraction system 50 includes a single restraint 58 implemented within each ride vehicle 84. Additionally, or alternatively, each ride vehicle 80 may have any suitable number of restraints 58, such as respective restraints 58 for each passenger 86 or multiple restraints 58 for a single passenger 86 (e.g., a respective restraint 58 for each of a passenger's legs, torso, lap and so forth).

Moreover, each ride seat 84 may include the padding system 56 that the passengers 86 may contact while positioned within the ride seat 84. As an example, the padding system 56 may be implemented on a back or back rest of the ride seat 84 to enable the passengers 86 to lean against the padding system 56 while positioned within the ride seat 84. Additionally, or alternatively, the padding system 56 may be implemented on a seating area of the ride seat 84 to enable the passengers 86 to sit on the padding system 56 while positioned within the ride seat 84. The padding system 56 may increase a comfort for the passengers 86. For example, the padding system 56 may provide a cushion to soften a surface of contact between the passengers 86 and the ride seat 84, mitigate impact of shock and movement of the passengers within the ride seat 84, provide insulation that reduces heat transfer between the passengers 86 and the ride seat 84, and so forth. Thus, the padding system 56 may improve an overall experience provided by the attraction system 50 to the passengers 86. Further, the padding system 56 is assembled from multiple modules or components that interlock about seams. The modularity facilitates efficient maintenance by allowing replacement, removal, separate handling of the various smaller components, and so forth. The interlocking about seams while the modules or components are installed helps block direct contact between the passengers 86 and the ride seat 84 at the location of the seams.

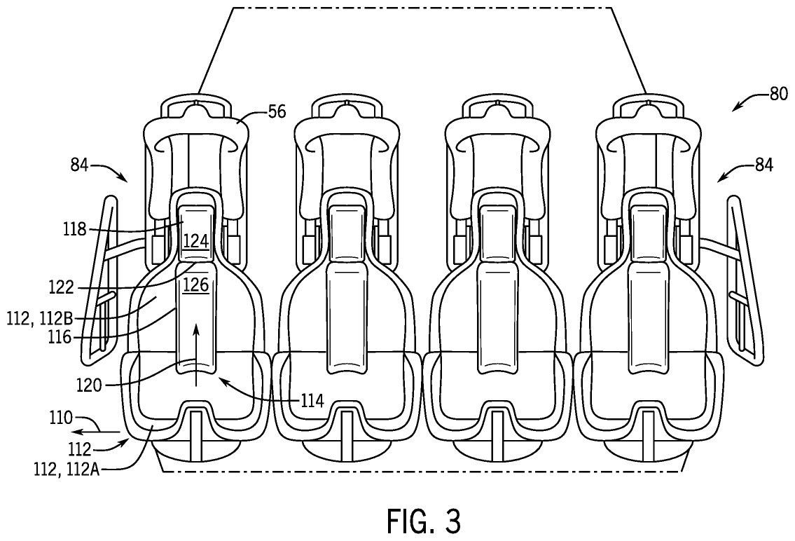

FIG. 3 is a front view of an embodiment of one of the ride vehicles 80, which may include individual ride seats 84 that may each receive a single passenger. In an additional or alternative embodiment, a single ride seat 84 may receive multiple passengers. Furthermore, although the ride vehicle 80 includes four ride seats 84 offset along a lateral axis 110 in the illustrated embodiment, the ride vehicle 80 may include any suitable number of ride seats 84 (e.g., one ride seat 84, two ride seats 84, three ride seats 84, more than four ride seats 84) positioned relative to one another in any suitable manner. Each individual ride seat 84 may include a base 112, which may be directly coupled to or secured to another component of the ride vehicle 80 (e.g., an enclosure of the ride vehicle 80). The base 112, for example, may include a first base portion 112A (e.g., a seating base) and/or a second base portion 112B (e.g., a back rest base) to help provide support for a passenger positioned in the ride seat 84. For instance, the passenger may sit on top of the first base portion 112A and lean against the second base portion 112B in the ride seat 84. The restraint 58, shown as an over-the-shoulder harness in the illustrated embodiment, may secure the passenger within the ride seat 84 and against the first base portion 112A and/or the second base portion 112B. The base 112 may be formed from a material, such as a plastic, a metal, a composite, a wood, and so forth, that may provide sufficient structural stability to support the passenger (e.g., a weight of the passenger) and facilitate securement within the ride vehicle 80 during operation of the attraction system, such as during movement of the ride vehicle 80.

Each ride seat 84 may also include a padding system 114 that may be coupled to the base 112 and provide additional comfort for the passenger within the ride seat 84. By way of example, the padding system 114 may provide cushioning that may be comfortable for the passenger during contact or impact between the passenger and the padding system 114. To this end, the padding system 114 may be formed from a material that may be of a lower durometer (e.g., a hardness measurement) than that of the base 112, such as a foam, a rubber, a felt, a synthetic fiber, and the like. Further, in the illustrated embodiment, the padding system 114 is positioned at pressure points along a centerline of the ride seat 84 (e.g., at points where the guest may likely exert the most force against and feel most contact with the ride seat 84), leaving a majority of the base 112 exposed. In an additional or alternative embodiment, the padding system 114 may be sized and positioned to block contact between the guest and a majority or all of the base 112.

The padding system 114 may be attached to the second base portion 112B of the ride seat 84. Thus, the passenger may lean into the ride seat 84 and against the padding system 114. For example, the padding system 114 may include a first pad portion 116 (e.g., a first pad) and a second pad portion 118 (e.g., a second pad). The first and second pad portions 116, 118 may be individual pieces or components that may be separately coupled to the second base portion 112B. In the illustrated embodiment, the first pad portion 116 and the second pad portion 118 are positioned along a vertical axis 120 and may be vertically abutting or adjacent to one another. In an additional or alternative embodiment, the first pad portion 116 and the second pad portion 118 may be horizontally adjacent or extend along different planes (e.g., one along the first base portion 112A and one along the second base portion 112B). Further, the first pad portion 116 and the second pad portion 118 may be representative of any number of interlocking pad portions in accordance with present embodiments.

The first pad portion 116 and the second pad portion 118 may interlock at an interface to block a guest from direct contact with the base 112 at the location of the interface. That is, an end of the first pad portion 116 may abut, face, or be positioned adjacent to a corresponding end of the second pad portion 118 and the positioning of the first pad portion 116 relative to the second pad portion 118 may form a seam 122 between the first pad portion 116 and the second pad portion 118. The seam 122 may extend along the respective ends of the first pad portion 116 and of the second pad portion 118. The configuration of the ends of the first pad portion 116 and the second pad portion 118 may create an overlap that blocks a direct contact with the base 112 through the seam 122. In an embodiment in which the first pad portion 116 and the second pad portion 118 abut one another, the seam 122 may include a direct interface where the first pad portion 116 is in contact with the second pad portion 118. In an embodiment in which the first pad portion 116 and the second pad portion 118 may be offset from (e.g., not in direct contact with) one another, the seam 122 may include a gap or space defining a labyrinth or angled passage extending between the first pad portion 116 and the second pad portion 118. In any case, as discussed herein, the first pad portion 116 and the second pad portion 118 may overlap with one another along the seam 122 to reduce exposure of the base 112 (e.g., the second base portion 112B) at the seam 122.

The first pad portion 116 and the second pad portion 118 may be separately or individually removable from the ride seat 84. That is, the first pad portion 116 may be detached from the second base portion 112B without detaching the second pad portion 118 from the second base portion 112B, and/or the second pad portion 118 may be detached from the second base portion 112B without detaching the first pad portion 116 from the second base portion 112B. Thus, an adjustability of the padding system 114 may be improved. For instance, in some circumstances, it may be desirable to perform service on (e.g., replace, cleanse, repair) one of the first pad portion 116 or the second pad portion 118 without performing service on the other of the first pad portion 116 or the second pad portion 118. In this manner, the first pad portion 116 or the second pad portion 118 may be removed from the ride seat 84 without having to remove an entirety of the padding system 114. As such, servicing of the padding system 114 may be more easily and/or more readily performed (e.g., at a reduced cost associated with removing both the first pad portion 116 and the second pad portion 118).

In an embodiment, the first pad portion 116 and the second pad portion 118 may be configured to attach to the base 112 using a common technique. As an example, the first pad portion 116 and/or the second pad portion 118 may be detachably coupled to the base 112 using a hook-and-loop fastener, a mechanical fastener (e.g., a screw, a rivet, a snap, a button, a zipper), a latch, an interference fit, or any suitable feature that may be unfastened without additional tooling and/or without affecting a structure of the pad portions 116, 118 and/or the base 112. As another example, the first pad portion 116 and/or the second pad portion 118 may be more permanently coupled to the base 112, such as using an adhesive, a weld, and so forth. Such features may also be unfastened, such as by using special tooling. Furthermore, the first pad portion 116 and the second pad portion 118 may be configured to detach from the base 112 using a common technique (e.g., undoing a hook-and-loop fastener, removing a mechanical fastener, dissolving adhesive). Thus, ease of coupling and/or decoupling of the first pad portion and the second pad portion 118 with respect to the second base portion 112B may be improved. In an additional or alternative embodiment, the first pad portion 116 and the second pad portion 118 may be configured to attach to the base 112 using different techniques, such as based on an relative frequency in which servicing is expected to be performed with respect to the first pad portion 116 and the second pad portion 118. For example, servicing may be performed more frequently for the second pad portion 118 than for the first pad portion 116. As such, the coupling between the second pad portion 118 and the base 112 may facilitate easier detachment of the second pad portion 118 from the base 112 as compared to the coupling between the first pad portion 116 and the base 112 to facilitate servicing of the padding system 114.

Moreover, the first pad portion 116 and the second pad portion 118 may cooperatively contact and support a substantial surface area of the passenger in order to provide a desirable amount of comfort for the passenger positioned within the ride seat 84. As an example, the first pad portion 116 may be coupled to the second base portion 112B to enable a torso of the passenger to rest against the first pad portion 116 within the ride seat 84, and the second pad portion 118 may be coupled to the second base portion 112B to enable a head of the passenger to rest against the second pad portion 118. Thus, the second pad portion 118 may be configured to be in contact with a smaller area of the passenger as compared to the first pad portion 116, and a surface 124 (e.g., an exposed surface, a passenger-facing surface, a surface opposite to a surface secured to the base 112) of the second pad portion 118, such as at a passenger-facing side of the padding system 114, may therefore have a smaller surface area than that of a surface 126 (e.g., an exposed surface, a passenger-facing surface, a surface opposite to a surface secured to the base 112) of the first pad portion 116, such as at a passenger-facing side of the padding system 114. However, in an additional or alternative embodiment, the first pad portion 116 and the second pad portion 118 may be secured to the second base portion 112B in any suitable manner to be positioned against any part of the passenger, and/or the first pad portion 116 and the second pad portion 118 may be of any suitable relative size. In a further embodiment, the first pad portion 116 and/or the second pad portion 118 may be secured to the first base portion 112A or to any suitable part of the base 112 of the ride seat 84 to provide comfort for the passenger. Further, additional pad portions with corresponding interfaces may be employed in accordance with present embodiments. For example, one pad portion may cover the first base portion 112A, and two additional pad portions may cover the second base portion 112b, each of the pad portions operable to interface with one another in accordance with present embodiments.

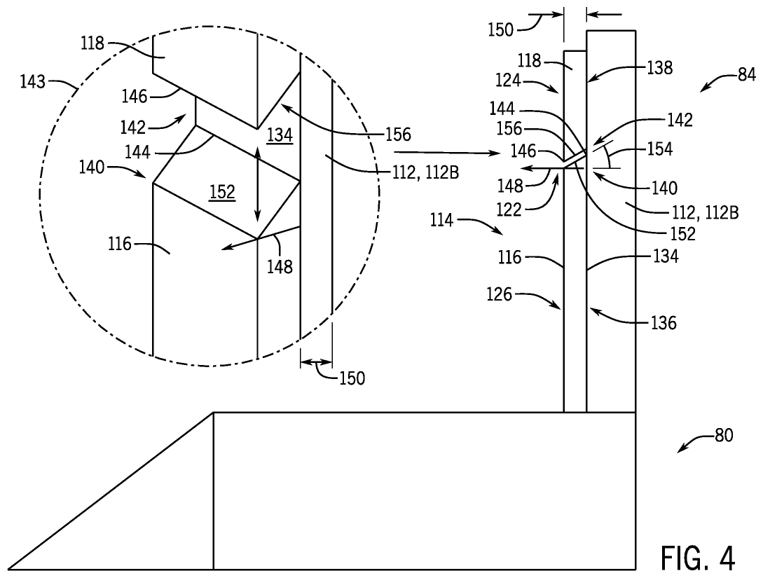

FIG. 4 is a side view of an embodiment of the ride vehicle 80 having the ride seat 84 and the padding system 114 coupled to a surface 134 (e.g., an inwardly facing surface, an interior surface, a guest-facing surface) of the second base portion 112B. For example, a side 136 (e.g., a base-facing side), such as a surface of the side 136, of the first pad portion 116, opposite the surface 126 of the first pad portion 116, may be configured to couple to the surface 134, and a side 138 (e.g., a base-facing side), such as a surface of the side 138, of the second pad portion 118, opposite the surface 124 of the second pad portion 118, may be configured to couple to the surface 134. The first pad portion 116 of the padding system 114 may have a first end 140, and the second pad portion 118 of the padding system 114 may have a second end 142. In an installed configuration of the padding system 114 on the ride seat 84, the first pad portion 116 and the second pad portion 118 may be positioned to form the seam 122, and the first pad portion 116 and the second pad portion 118 may overlap with one another at the seam 122 along the surface 134.

By way of example, as illustrated in detailed view 143 that further shows the coupling between the first pad portion 116, the second pad portion 118, and the second base portion 112B, a first edge 144 of the first pad portion 116 at the first end 140 may be positioned between the surface 134 of the second base portion 112B and a second edge 146 of the second pad portion 118 at the second end 142 with respect to an axis 148 (e.g., a longitudinal axis), such as a guest engagement axis generally along which a guest positioned within the ride vehicle 80 may impart a force onto the padding system 114. For example, the axis 148 may extend along a thickness 150 of the padding system 114 (e.g., of the first pad portion 116, of the second pad portion 118), such as from the surface 134, through the side 136 of the first pad portion 116, and to the surface 126 of the first pad portion 116. The first edge 144 of the first pad portion 116 may be in engagement with the surface 134, and the second end 142 of the second pad portion 118 may extend over the first end 140 relative to the second base portion 112B such that the second edge 146 of the second pad portion 118 is positioned further beyond the surface 134 along the axis 148. In this manner, the seam 122 may extend acutely and downwardly away from the surface 134 (e.g., toward a seating area of the ride seat 84) with respect to the axis 148.

The first end 140 may have a first end surface 152 (e.g., a first beveled surface) that extends downwardly (e.g., toward a seating area of the ride seat 84) away from the surface 134 with respect to the axis 148 in the installed configuration, thereby forming an oblique angle 154 with respect to the axis 148. Moreover, the second end 142 may have a second end surface 156 (e.g., a second beveled surface) that extends downwardly (e.g., toward a seating area of the ride seat 84) away from the surface 134 to form an angle generally in alignment with the oblique angle 154 or at any suitable oblique angle with respect to the axis 148 in the installed configuration. The angled arrangement of the ends 140, 142 may enable desirable engagement or abutment between the first end 140 and the second end 142, such as to enable the first end surface 152 and the second end surface 156 to be positioned flush or substantially flush against one another or otherwise to provide a desirable overlap (e.g., along the axis 148) between the pad portions 116, 118 at the ends 140, 142. Thus, an interface between the first end 140 and the second end 142 may form the seam 122 that defines the overlap of the pad portions 116, 118 along the axis 148.

The overlap between the first pad portion 116 and the second pad portion 118 may provide a desirable amount of compliance along the seam 122. For example, a force imparted onto the second pad portion 118 at the seam 122 by a guest (e.g., a passenger) may cause the second pad portion 118 to deform toward the second base portion 112B, but the first pad portion 116 may block contact between the second pad portion 118 and the second base portion 112B and, for example, block contact between the guest and the second base portion 112B at the seam 122. Indeed, the first pad portion 116 and the second pad portion 118 may be manufactured such that the oblique angle 154 and/or the thickness 150 associated with the pad portions 116, 118 may provide a sufficient amount of overlap between the pad portions 116, 118 and/or provide sufficient structural strength for the pad portions 116, 118 to resist deformation, while limiting an amount of material used to form the pad portions 116, 118. By way of example, the oblique angle 154 may be between 30 degrees and 60 degrees (e.g., 45 degrees), and the overall thickness 150 along the axis 148 may be between 1 centimeter (0.4 inches) to 10 centimeters (4 inches). Such a configuration many enable the first pad portion 116 and the second pad portion 118 to cooperatively block exposure of the second base portion 112B along the axis 148 at the seam 122 and correspondingly block contact between the guest and the second base portion 112B at the seam 122.

The geometry of the first end 140 and the second end 142 may also provide a manufacturing tolerance to accommodate variations in dimensions associated with manufacture of different pad portions 116, 118. By way of example, the first end 140 of the first pad portion 116 may not directly correspond to the second end 142 of the second pad portion 118. For instance, the first end surface 152 and the second end surface 154 may be oriented at different angles relative to the axis 148, the thickness 150 of the first pad portion 116 at the first end 140 may be different than the thickness 150 of the second pad portion 118 at the second end 142, and so forth. However, the pad portions 116, 118 may nevertheless be secured to the second base portion 112B in an arrangement in which the first end 140 and the second end 142 overlap at the seam 122 along the axis 148. For example, a saw tooth configuration (instead of individual complementary slopes) or dovetail mating features may be employed to create the overlap. Additionally, or alternatively, certain sections or areas of the ends 140, 142 of the pad portions 116, 118 may not be directly in contact with or abut one another in the installed configuration (e.g., the pad portions 116, 118 may not be completely flush with one another). However, the ends 140, 142 may nevertheless sufficiently overlap at the seam 122 and block exposure of the second base portion 112B at the seam 122. Thus, the profile of the pad portions 116, 118 may enable the padding system 114 to provide the benefits disclosed herein with varying sizing and dimensioning of the pad portions 116, 118, thereby facilitating ease of manufacture and/or installation of the padding system 114.

The downward extension of the seam 122 relative to the axis 148 away from the surface 134 (e.g., toward a seating area of the ride seat 84) may also facilitate ease of installation of the padding system 114. For example, because the second end 142 of the second pad portion 118 is configured to extend over the first end 140 of the first pad portion 116 relative to the second base portion 112B, the second pad portion 118 may be more readily attached to and/or detached from the second base portion 112B. That is, the positioning of the second end 142 over the first end 140 may facilitate positioning of the second pad portion 118 over the surface 134 of the second base portion 112B and over the first pad portion 116. Additionally, the first end 140 of the first pad portion 116 may not block relative movement of the second pad portion 118 away from the surface 134 (e.g., along the axis 148), thereby facilitating detachment of the second pad portion 118 from the surface 134. The downward extension of the seam 122 relative to the axis 148 away from the surface 134 may further facilitate removal of particles, such as dust and/or debris, from within the seam 122. For example, the orientation of the seam 122 may enable a gravitational force to drive particles through the seam 122 (e.g., away from the surface 134) to avoid unwanted accumulation of the particles within the seam 122.

In an additional or alternative embodiment, the pad portions 116, 118 may be manufactured such that the ends 140, 142 extend upwardly relative to the axis 148 away from the surface 134 (e.g., away from a seating area of the ride seat 84). That is, the first end 140 of the first pad portion 116 may extend over the second end 142 of the second pad portion 118 relative to the second base portion 112B (as observed for the guest-facing side of the ride seat 84). To this end, the first end surface 152 of the first pad portion 116 may extend upwardly away from the surface 134 with respect to the axis 148 (e.g., away from a seating area of the ride seat 84) in the installed configuration, and the second end surface 156 of the second pad portion 118 may extend upwardly away from the surface 134 with respect to the axis 148 (e.g., away from a seating area of the ride seat 84) in the installed configuration. In such an embodiment, the first pad portion 116 may be more readily positioned over the surface 134 of the second base portion 112B and over the second pad portion 118. Additionally, the second end 142 of the second pad portion 118 may not block relative movement of the first pad portion 116 away from the surface 134 (e.g., along the axis 148), thereby enabling the first pad portion 116 to be more readily detached from the second base portion 112B.

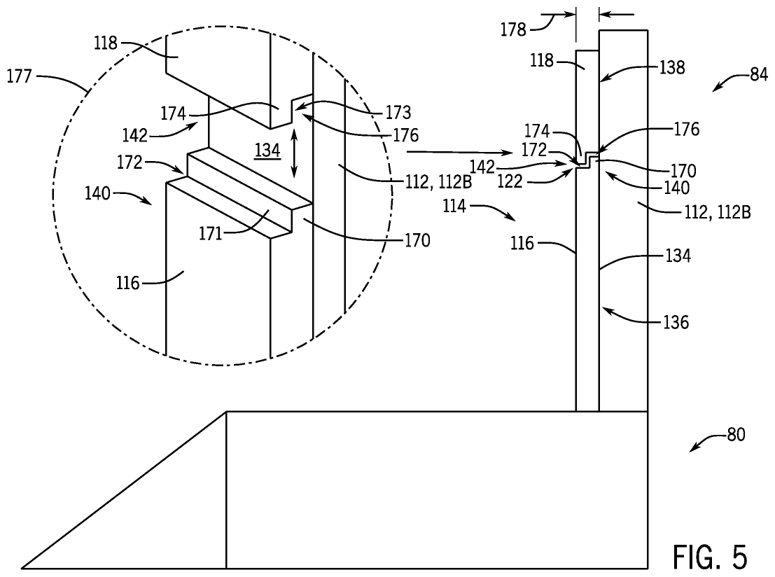

FIG. 5 is a side view of an embodiment of the ride vehicle 80 having the ride seat 84 and the padding system 114 coupled to the surface 134 of the second base portion 112B (e.g., at the side 136 of the first pad portion 116, at the side 138 of the second pad portion 118). Each of the illustrated pad portions 116, 118 of the padding system 114 includes a step profile. For example, the first pad portion 116 may include a first protrusion, extension, or lip 170 and a first recess 172 formed via the first protrusion 170. The second pad portion 118 may include a second protrusion, extension, or lip 174 and a second recess 176 formed via the second protrusion 174. The first protrusion 170 of the first pad portion 116 and the second protrusion 174 of the second pad portion 118 may be complementary to one another. For example, the shape and dimension of the first protrusion 170 and the first recess 172 may generally match that of the second protrusion 174 and the second recess 176. Thus, in an installed configuration of the padding system 114, the second recess 176 of the second pad portion 118 may receive the first protrusion 170 of the first pad portion 116, and the first recess 172 may receive the second protrusion 174 of the second pad portion 118. In this manner, the first protrusion 170 and the second protrusion 174 may overlap with one another along the second base portion 112B and form the seam 122 (e.g., a labyrinth passage) extending between the pad portions 116, 118. The overlap between the step profiles of the pad portions 116, 118 may block exposure of the base portion 112B at the seam 122. In an additional or alternative embodiment, multiple of such recesses and protrusions may be employed to increase the layers of the seam 122, such as by increasing waves of passes provided by the labyrinth passage.

As an example, the padding system 114 may block contact between a guest (e.g., a passenger) and the second base portion 112B at the seam 122. In the illustrated embodiment, the first protrusion 170 is in engagement with the surface 134, and the second protrusion 174 extends over the first protrusion 170 relative to the second base portion 112B such that the second protrusion 174 and the second base portion 112B cooperatively capture the first protrusion 170 and block movement of the first protrusion 170 away from the surface 134. A force imparted by the guest onto the second protrusion 174 may cause the second protrusion 174 to deform toward the second base portion 112B. However, the first protrusion 170 may block contact between the second protrusion 174 and the second base portion 112B and therefore block contact between the guest and the second base portion 112B. Indeed, in an embodiment, the first protrusion 170 and the second protrusion 174 may abut one another in the installed configuration of the padding system 114 to facilitate blocking exposure of the base portion 112B at the seam 122.

The illustrated embodiment in which the second protrusion 174 of the second pad portion 118 extends over the first protrusion 170 of the first pad portion 116 may facilitate attachment of the second pad portion 118 to the second base portion 112B and/or detachment of the second pad portion 118 from the second base portion 112B. For example, in detailed view 177 further illustrating the coupling between the first pad portion 116, the second pad portion 118, and the second base portion 112B, the first pad portion 116 is coupled to the surface 134 of the second base portion 112B. The first recess 172 of the first pad portion 116 may remain exposed while the first pad portion 116 is coupled to the surface 134. For instance, a first protrusion surface 171 of the first protrusion 170 may face away from the surface 134. Therefore, the second protrusion 174 may be more easily inserted into the first recess 172, such as by placing a second protrusion surface 173 of the second protrusion 174 over the first protrusion surface 171 to position the second pad portion 118 in engagement with the surface 134. Thus, the first protrusion 170 may be positioned between the surface 134 and the second protrusion 174 while the first pad portion 116 and the second pad portion 118 are coupled to the second base portion 112B. Such an arrangement of the first pad portion 116 (e.g., the first protrusion 170) with respect to the second pad portion 118 may avoid blocking movement of the second pad portion 118 away from the surface 134, thereby enabling the second pad portion 118 to be more easily removed from the surface 134. However, the second protrusion 174 may block movement of the first protrusion 170, and therefore of the first pad portion 116, away from the surface 134 to secure the first pad portion 116 to the second base portion 112B.

In an additional or alternative embodiment, the second protrusion 174 of the second pad portion 118 may be in engagement with the surface 134, and the first protrusion 170 of the first pad portion 116 may extend over the second protrusion 174. That is, the first protrusion 170 and the second base portion 112B may cooperatively capture the second protrusion 174 and block movement of the second protrusion 174 away from the surface 134. In such an embodiment, the first pad portion 116 may be more easily attached to and/or detached from the second base portion 112B. For example, in such an embodiment, the second recess 176 may remain exposed (e.g., the second protrusion surface 173 may face away from the surface 134) while the second pad portion 118 is coupled to the surface 134 to enable placement of the first protrusion 170 over the second protrusion 174 to position the first pad portion 116 in engagement with the surface 134.

In an embodiment, the first protrusion 170 and the second protrusion 174 may have a common shape or geometry. For example, each of the first protrusion 170 and the second protrusion 174 may have a thickness that is approximately half of a total, overall, or combined thickness 178 of the padding system 114 (e.g., a total thickness of the first pad portion 116, a total thickness of the second pad portion 118). Moreover, the first protrusion 170 and the second protrusion 174 may extend approximately the same length and/or at approximately the same angle (e.g., in parallel with one another). Such geometry of the first protrusion 170 and the second protrusion 174 may facilitate engagement between the ends 140, 142 of the pad portions 116, 118, such as to enable receipt of the first protrusion 170 at the second recess 176 and/or receipt of the second protrusion 174 at the first recess 172. However, the first protrusion 170 and/or the second protrusion 174 may have any suitable shape that enables the pad portions 116, 118 to overlap at the seam 122. Indeed, the step profile of the pad portions 116, 118 may provide tolerances that accommodate variations in dimensioning of the pad portions 116, 118 and/or installed positioning of the pad portions 116, 118 to enable the ends 140, 142 of the pad portions 116, 118 to overlap along the seam 122.

In one embodiment, the respective thicknesses of the protrusions 170, 174 may be greater than a threshold thickness to provide a desirable amount of structural stability or rigidity for the protrusions 170, 174. As a result, the thickness 178 of the pad portion 114 may also be above a threshold value. For example, the thickness 178 (e.g., greater than 2.5 centimeters or 1 inch) of the embodiment of the pad portion 114 illustrated in FIG. 5 may be greater than the thickness 150 of the embodiment of the pad portion 114 illustrated in FIG. 4.

Moreover, it should be noted that the pad portions 116, 118 may have any other suitable profile configured to overlap with one another at the seam 122 to block exposure of the base 112 at the seam 122. By way of example, the ends 140, 142 of the pad portions 116, 118 may form a dovetail joint, a lap joint, a mortise and tenon joint, and so forth configured to overlap with one another. Indeed, a part of one of the pad portions 116, 118 may be configured to insert into the other of the pad portions 116, 118 to facilitate securement of the pad portions 116, 118 to one another and maintain the overlap at the seam 122.

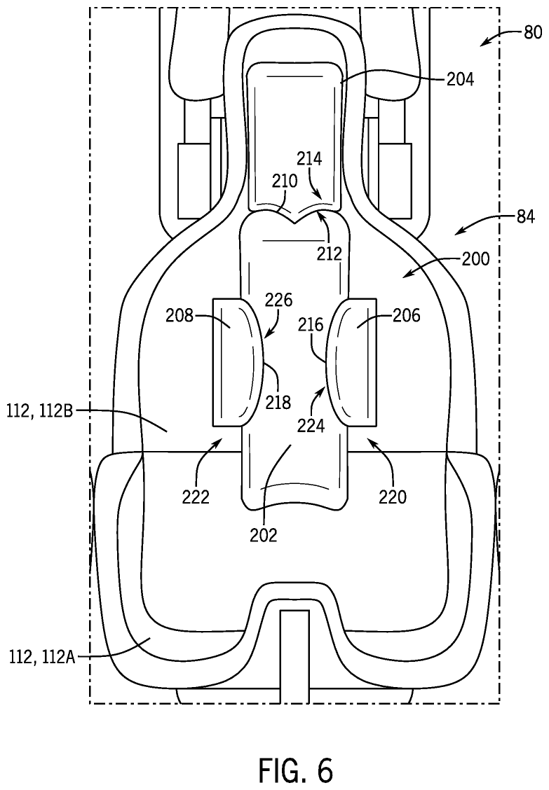

FIG. 6 is a front view of an embodiment of a ride seat 84 of the ride vehicle 80. In the illustrated embodiment, the ride seat 84 includes a padding system 200 attached to the second base portion 112B of the ride seat 84. In an additional or alternative embodiment, the padding system 200 may couple to the first base portion 112A. The illustrated padding system 200 includes a first pad portion 202, a second pad portion 204, a third pad portion 206, and a fourth pad portion 208. The first pad portion 202 is positioned relative to the second pad portion 204 to form a first seam 210 extending between the first pad portion 202 and the second pad portion 204. The first seam 210 may not extend in a continual linear manner across the second base portion 112B. For example, in the illustrated embodiment, the first seam 210 has a V-shape extending across the second base portion 112B. In this way, a first end 212 of the first pad portion 202 forms a recess or channel configured to receive a second end 214 of the second pad portion 204, and the first end 212 is operable to capture the second end 214. Such geometry of the first pad portion 202 and the second pad portion 204 may facilitate desirable alignment between the first end 212 and the second end 214 and therefore enable desirable positioning between the first pad portion 202 and the second pad portion 204. Moreover, the first end 212 of the first pad portion 202 and the second end 214 of the second pad portion 204 may overlap with one another along the first seam 210. For example, the first end 212 and the second end 214 may have profiles similar to that described above to block exposure of the second base portion 112B at the first seam 210.

Additionally, the third pad portion 206 may be positioned relative to the first pad portion 202 to form a second seam 216 extending between the first pad portion 202 and the third pad portion 206. The fourth pad portion 208 may be positioned relative to the first pad portion 202 to form a third seam 218 extending between the first pad portion 202 and the fourth pad portion 208. The first pad portion 202 (e.g., a first side 220 and a second side 222 of the first pad portion 202), the third pad portion 206 (e.g., a third end 224 of the third pad portion 206), and the fourth pad portion 208 (e.g., a fourth end 226 of the fourth pad portion 208) are non-linearly shaped in the illustrated embodiment such that the second seam 216 and the third seam 218 extend in a non-linear direction across the second base portion 112B. The corresponding parts of the first pad portion 202, the third pad portion 206, and the fourth pad portion 208 may overlap with one another at the second seam 216 and the third seam 218, respectively, to block exposure of the second base portion 112B at the second seam 216 and the third seam 218. Moreover, the second seam 216 and the third seam 218 may extend along different parts of the first pad portion 202 than the first seam 210. For example, the first side 220 of the first pad portion 202 where the second seam 216 extends and the second side 222 of the first pad portion 202 where the third seam 218 extends may be opposite lateral sides of the first pad portion 202. In additional or alternative embodiments, the padding system 114 may include any other suitable pad portions (e.g., having any suitable shape or geometry) positioned to form a seam between the pad portions. Indeed, the seam may have any suitable shape and be positioned at any suitable part of the ride seat 84, and the pad portions may overlap with one another along the seam.

Although FIGS. 2-6 illustrate respective padding systems that are incorporated in a ride vehicle (e.g., in a ride seat), the padding systems may be implemented in any suitable context (e.g., a theatre seating). For example, any of the padding systems described herein may be incorporated in a seat that is separate from a ride vehicle or in another suitable feature that a guest may be positioned against. Indeed, the padding system may be used in any suitable attraction system or for a feature that is unrelated to an attraction system, such as on bench seating that is positioned external to an attraction system.

While only certain features of the disclosure have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. A seat for an amusement park attraction system, the seat comprising:
a base configured to support a guest;
a padding system having a first side that is guest-facing and a second side that is base-facing and opposite the first side;
a first pad portion of the padding system, wherein the first pad portion is coupled to the base;
a second pad portion of the padding system, wherein the second pad portion is coupled to the base; and
a seam formed by an interface between a first end of the first pad portion and a second end of the second pad portion such that the seam defines an overlap of the first pad portion and the second pad portion along an axis extending from the first side to the second side of the padding system.

2. The seat of claim 1, wherein the first end of the first pad portion comprises a first end surface that abuts a second end surface of the second end of the second pad portion.

3. The seat of claim 2, wherein the base comprises a base surface that extends in a first direction, the first pad portion and the second pad portion are coupled to the base surface, and each of the first end surface and the second end surface extends obliquely relative to the first direction in a second direction.

4. The seat of claim 2, wherein the first pad portion comprises a first portion of the first side, the second pad portion comprises a second portion of the first side, and the first portion of the first side has a larger surface area than that of the second portion of the first side.

5. The seat of claim 4, wherein the second end of the second pad portion is positioned between the base and the first end of the first pad portion along the axis.

6. The seat of claim 1, wherein the first pad portion comprises a first protrusion, and the second pad portion comprises a second protrusion that is complementary to the first protrusion.

7. The seat of claim 6, wherein the first protrusion is directly coupled to the base via the second side, and the base and the second protrusion cooperatively capture the first protrusion.

8. The seat of claim 1, wherein each of the first pad portion and the second pad portion comprises a lower durometer than that of the base.

9. An amusement park attraction system, comprising:
a guest support comprising:
a base having a base surface; and
a padding system comprising:
a first pad with a guest-facing surface, wherein the first pad is configured to engage with the base surface; and
a second pad configured to engage with the base surface to form an overlap between a first end of the first pad and a second end of the second pad along an axis extending from the base surface to the guest-facing surface in an installed configuration of the padding system.

10. The amusement park attraction system of claim 9, wherein the first end of the first pad and the base surface cooperatively capture the second end of the second pad in the installed configuration of the padding system.

11. The amusement park attraction system of claim 9, comprising a seam formed by an interface between the first pad and the second pad, wherein the seam extends obliquely relative to the base surface and the axis.

12. The amusement park attraction system of claim 9, wherein the first pad comprises a protrusion, the second pad comprises a recess, and the recess of the second pad is configured to receive the protrusion of the first pad.

13. The amusement park attraction system of claim 9, comprising a ride vehicle, wherein the guest support is positioned within the ride vehicle.

14. The amusement park attraction system of claim 9, wherein the first pad and the second pad are detachably coupled to the base surface.

15. A seat, comprising:
a base comprising a surface;
a first pad coupled to the surface of the base at a first base-facing side of the first pad;
a second pad coupled to the surface of the base at a second base-facing side of the second pad; and
a seam formed by an interface between a first end of the first pad and a second end of the second pad, wherein the first end and the second end overlap with one another at the seam along a guest engagement axis extending through the first pad, the second pad, and the base.

16. The seat of claim 15, wherein each of the first end and the second end comprises a respective beveled surface, and the respective beveled surfaces overlap with one another along the seam along the guest engagement axis.

17. The seat of claim 15, wherein each of the first end and the second end comprises a respective step profile, and the respective step profiles overlap with one another at the seam along the guest engagement axis.

18. The seat of claim 15, wherein the base comprises a back rest of the seat.

19. The seat of claim 15, wherein the first pad and the second pad are separately detachable from the base.

20. The seat of claim 15, wherein the first pad comprises a first protrusion forming a first recess of the first pad, the second pad comprises a second protrusion forming a second recess of the second pad, the first recess of the first pad receives the second protrusion of the second pad, and the second recess of the second pad receives the first protrusion of the first pad such that the first protrusion and the second protrusion overlap with one another at the seam along the guest engagement axis.
